(19) United States
(12) Patent Application Publication
(10) Pub. No.: US 2026/0074477 A1
(43) Pub. Date: Mar. 12, 2026

(54) Connector and Electrical Connection Assembly

(71) Applicants: TE Connectivity Solutions GmbH, Schaffhausen (CH); Tyco Electronics (Shanghai) Co., Ltd., Shanghai (CN)

(72) Inventors: Jiaoyong (Mac) Liu, Shanghai (CN); Jie (Roger) Luo, Shunde (CN); Wei Yao, Kunshan (CN); Patrick Di Paola, Middletown, PA (US)

(73) Assignees: TE Connectivity Solutions GmbH, Schaffhausen (CH); Tyco Electronics (Shanghai) Co., Ltd., Shanghai (CN)

(21) Appl. No.: 19/317,444

(22) Filed: Sep. 3, 2025

(30) Foreign Application Priority Data
Sep. 6, 2024 (CN) 202411253910.0
Jul. 30, 2025 (CN) 202511065033.9

(51) Int. Cl. H01R 25/14

(52) U.S. Cl. CPC H01R 25/142

(57) ABSTRACT

A connector includes an insulation shell, a pair of contact terminals, and a pair of connection terminals. The insulation shell has a front mating port and a rear opening, a pair of side openings, and two receiving chambers. The pair of contact terminals are each installed into one of two receiving chambers of the insulation shell and each have a front contact part and a side contact part. The pair of connection terminals are each inserted into one of the pair of side openings and each mate with one side contact part. Each front contact part is in the front mating port and electrically contacts a mating plug of a mating connector inserted into the front mating port. A part of each connection terminal is exposed from one side opening for electrical connection to an electrical connecting member.

### CROSS-REFERENCE TO RELATED APPLICATIONS

This application claims the benefit of the filing date under 35 U.S.C. § 119(a)-(d) of Chinese Patent Application No. CN202411253910.0, filed on Sep. 6, 2024, and Chinese Patent Application No. CN202511065033.9, filed on Jul. 30, 2025.

### FIELD OF THE INVENTION

The present invention relates to a connector and, more particularly, to a connector and an electrical connection assembly comprising the connector.

### BACKGROUND OF THE INVENTION

A connector typically includes an insulation shell and terminals arranged within the insulation shell. The insulation shell has front and rear ports that are opposite in its longitudinal direction. The front end of the terminal is in the front port of the insulation shell, and used for electrical contact with a mating plug of an inserted mating connector. The rear end of the terminal extends from the rear port of the insulation shell along the longitudinal direction of the insulation shell, and is used to connect with an electrical connecting member such as a busbar. Typically, the length dimension of the terminal in the longitudinal direction is relatively large, resulting in a large length dimension of the entire connector in the longitudinal direction. The large length dimension of the entire connector in the longitudinal direction makes meeting some specific application situations difficult and limits the application range of the connector.

### SUMMARY OF THE INVENTION

A connector includes an insulation shell, a pair of contact terminals, and a pair of connection terminals. The insulation shell has a front mating port and a rear opening opposite each other in a longitudinal direction of the insulation shell, a pair of side openings opposite in a transverse direction of the insulation shell, and two receiving chambers arranged side by side in the transverse direction. The pair of contact terminals are each installed into one of two receiving chambers of the insulation shell and each have a front contact part and a side contact part. The pair of connection terminals are each inserted into one of the pair of side openings and each mate with one side contact part. Each front contact part is located in the front mating port and electrically contacts a mating plug of a mating connector inserted into the front mating port. A part of each connection terminal is exposed from one side opening for electrical connection to an electrical connecting member.

### BRIEF DESCRIPTION OF DRAWINGS

The invention will now be described by way of example with reference to the accompanying figures, of which:

FIG. 1 shows a perspective view of a connector according to an exemplary embodiment;

FIG. 2 is a horizontal sectional view of the connector of FIG. 1;

FIG. 3 is a horizontal sectional view of the connector of FIG. 1, with one contact terminal and one connection terminal removed;

FIG. 4 is a horizontal sectional view of an insulation shell of the connector of FIG. 1;

FIG. 5 is a perspective view of a pair of contact terminals and a pair of connection terminals of the connector of FIG. 1;

FIG. 6 is a perspective view of the connection terminal of FIG. 3 and a sleeve of the connector of FIG. 1;

FIG. 7 is an exploded view of the connection terminal of FIG. 3;

FIG. 8 is an assembly view of the contact terminal of FIG. 3 and an elastic member of the connector of FIG. 1;

FIG. 9 is an exploded view of the contact terminal of FIG. 3 and the elastic member of FIG. 8;

FIG. 10 is a horizontal sectional view of a connector according to another exemplary embodiment;

FIG. 11 is a horizontal sectional view of the connector of FIG. 10, with one contact terminal and one connection terminal removed;

FIG. 12 is a horizontal sectional view of an insulation shell of the connector of FIG. 10;

FIG. 13 is a perspective view of a pair of contact terminals and a pair of connection terminals of the connector of FIG. 10;

FIG. 14 is an assembly view of a shuttle member and an elastic member of the connector of FIG. 10;

FIG. 15 is an exploded view of the shuttle member of FIG. 14 and the elastic member of FIG. 14;

FIG. 16 is an assembly view of the contact terminal of FIG. 11 and a collar part of the elastic member of FIG. 14;

FIG. 17 is an exploded view of the contact terminal of FIG. 11 and the collar part of FIG. 16;

FIG. 18 is a horizontal sectional view of a connector according to yet another exemplary embodiment;

FIG. 19 is an assembly view of a connection terminal of the connector of FIG. 18;

FIG. 20 is an exploded view of the connection terminal of FIG. 19; and

FIG. 21 is a perspective view of an electrical connection assembly according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

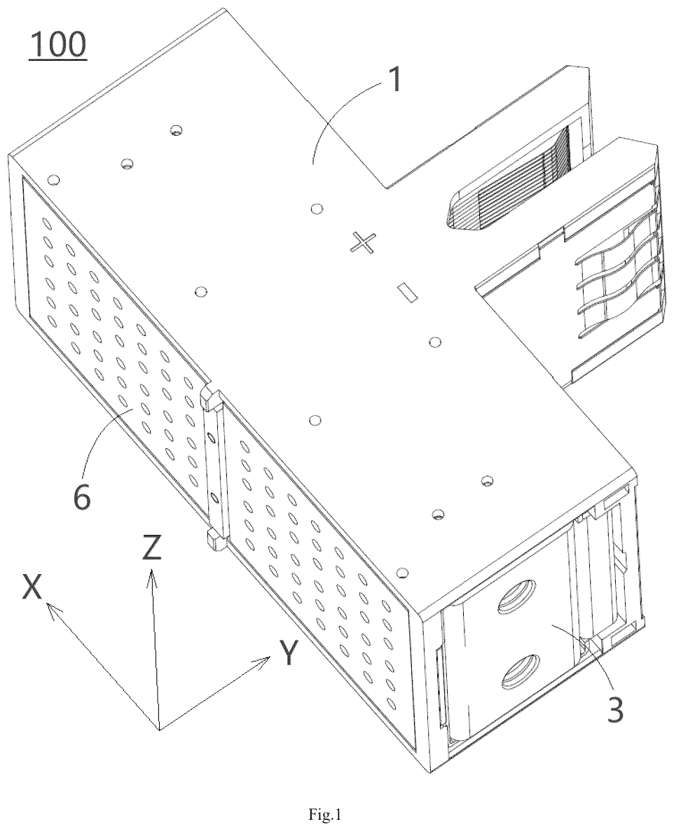

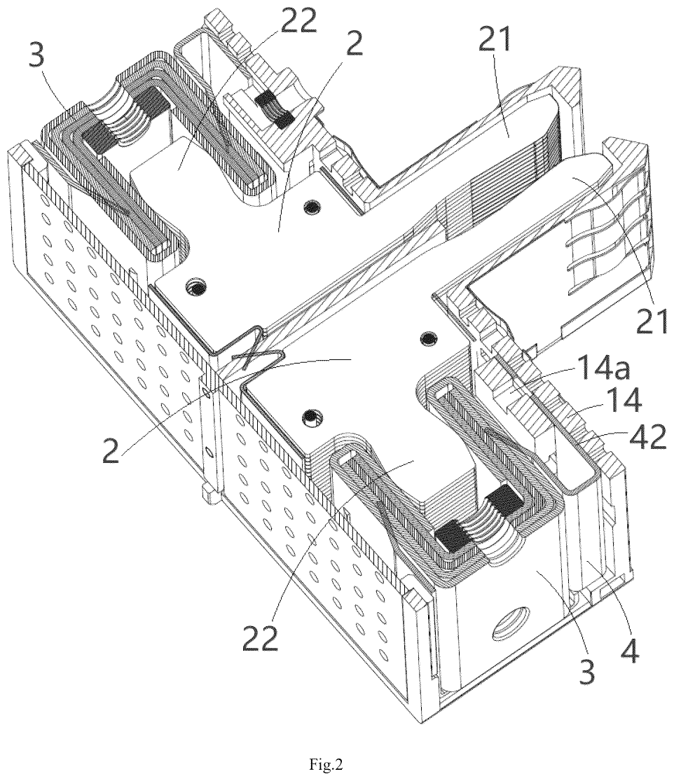

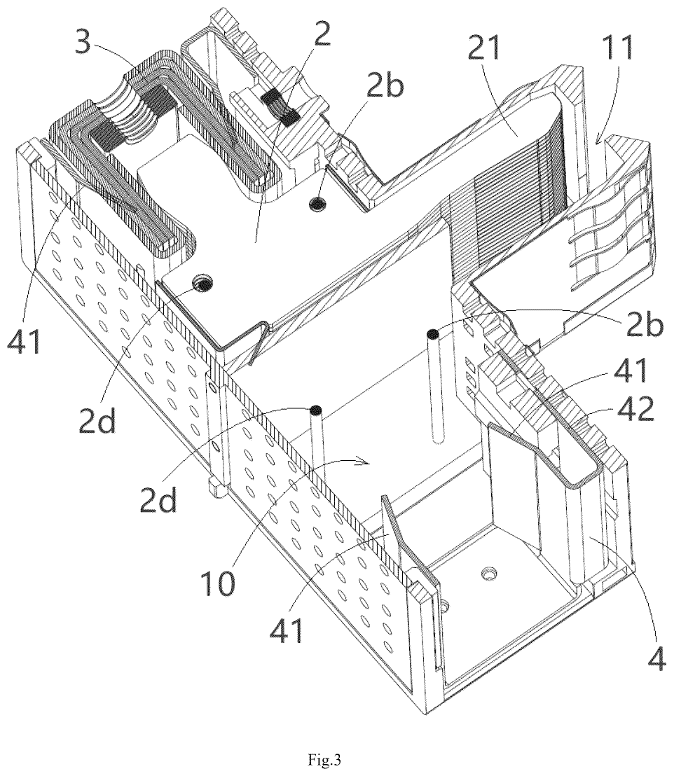

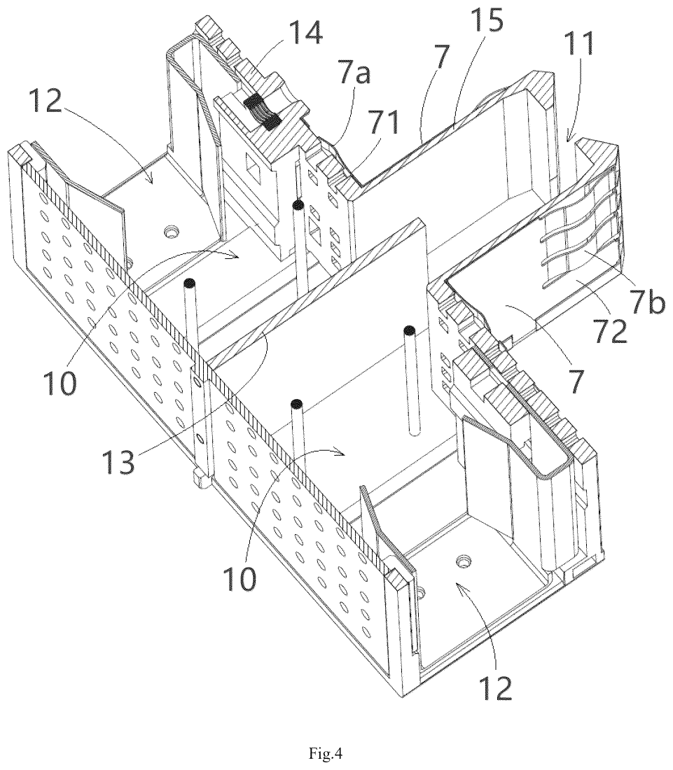

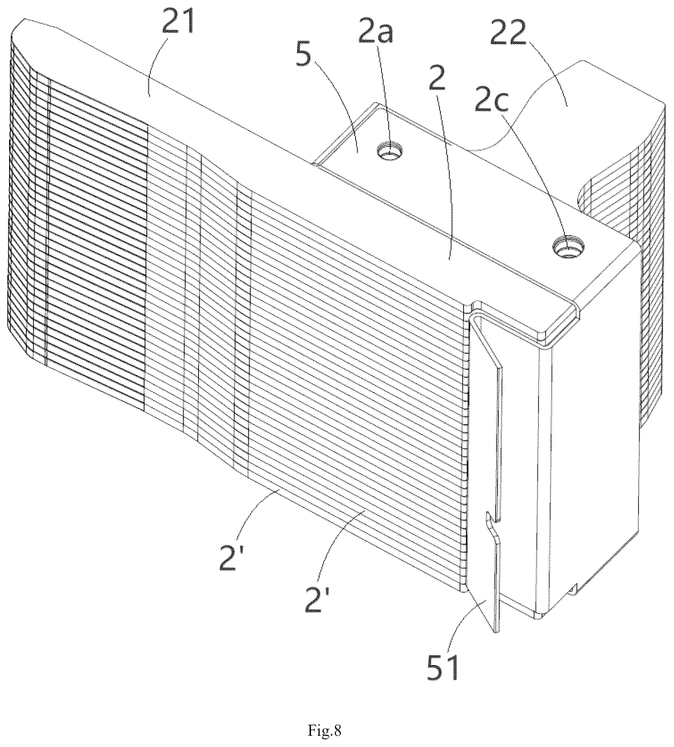

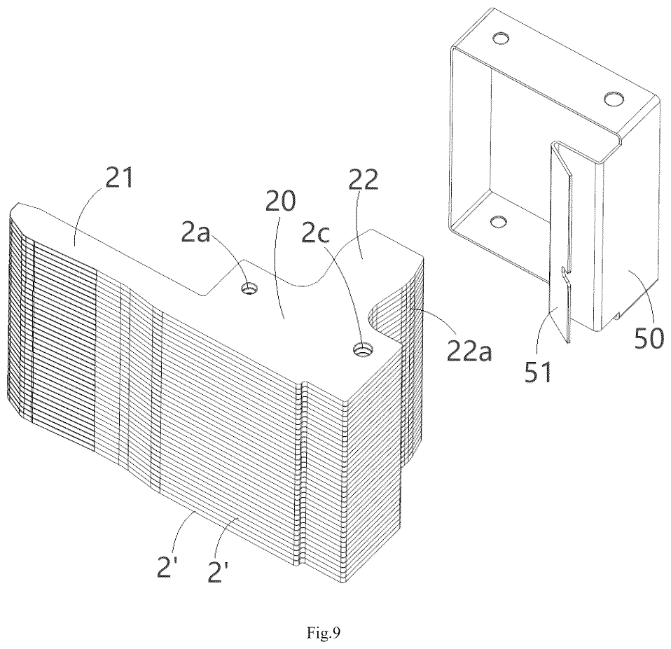

An exemplary embodiment of a connector 100 will now be described with reference to FIGS. 1-9. As shown in FIGS. 1-2, the connector 100 includes an insulation shell 1, a pair of contact terminals 2, and a pair of connection terminals 3. As shown in FIGS. 3-4, the insulation shell 1 has a front mating port 11 and a rear opening that are opposite in its longitudinal direction Y, a pair of side openings 12 that are opposite in its transverse direction X, and two receiving chambers 10 arranged side by side in its transverse direction X. The pair of contact terminals 2 are respectively installed in two receiving chambers 10 of the insulation shell 1. As shown in FIGS. 8-9, each contact terminal 2 has a front contact part 21 and a side contact part 22. The pair of connection terminals 3 are respectively inserted into the pair of side openings 12 of the insulation shell 1 and respectively mated with the side contact parts 22 of the pair of contact terminals 2. The front contact part 21 of a pair of contact terminals 2 is located in the front mating port 11 of the insulation shell 1, and is used to make electrical contact with a mating plug of a mating connector inserted into the front mating port 11. A part (or connection part) of the connection terminal 3 is exposed from the side opening 12, as shown in FIG. 2, of the insulation shell 1 for electrical connection to an electrical connecting member 8.

As shown in FIG. 2, the connection terminal 3 is U-shaped, and the side contact part 22 of the contact terminal 2 is inserted into the connection terminal 3. The connection terminal 3 is in sliding electrical contact with the side contact part 22 and can slide along the transverse direction X relative to the side contact part 22, thereby absorbing transverse manufacturing errors and transverse installation errors.

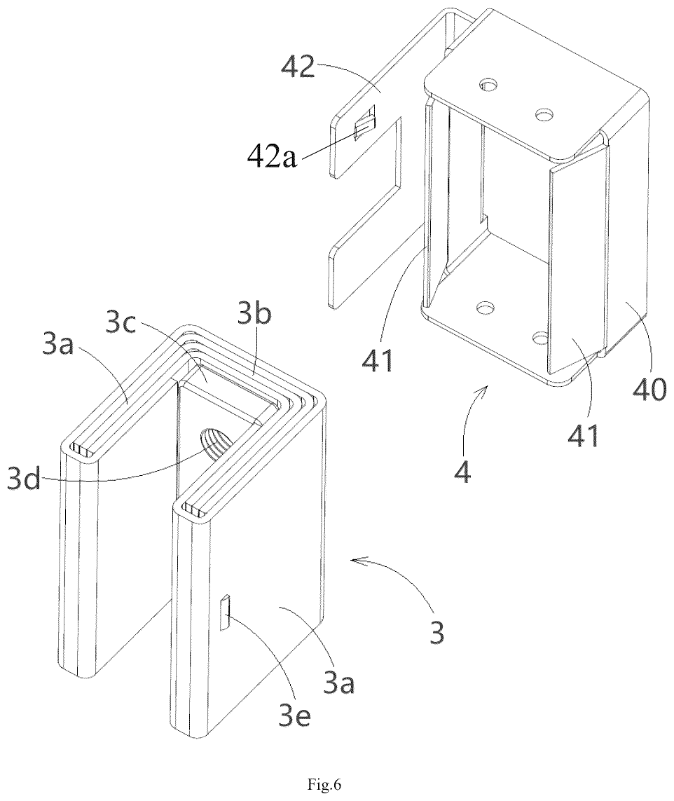

As shown in FIG. 6, the connection terminal 3 includes a pair of side plate parts 3a opposite each other in the longitudinal direction Y and a bottom plate part 3b located between the pair of side plate parts 3a. The side contact part 22 of the contact terminal 2 is inserted between the pair of side plate parts 3a of the connection terminal 3 and makes sliding electrical contact with the pair of side plate parts 3a.

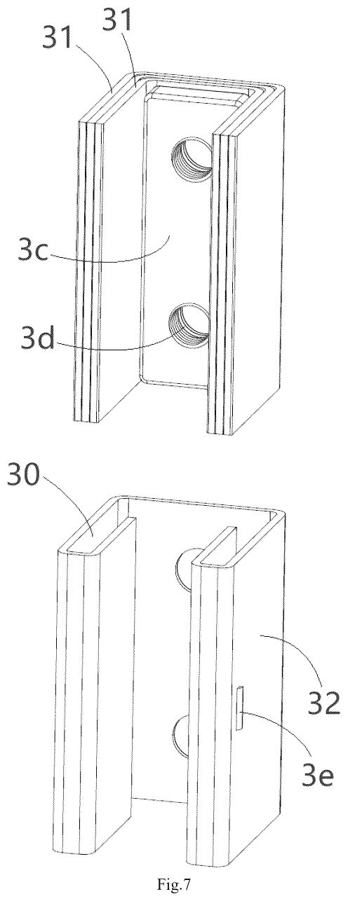

As shown in FIGS. 6-7, the connector 100 further comprises a connecting plate 3c, which is arranged on the inner side of the bottom plate part 3b of the connection terminal 3 and formed with a threaded hole 3d for connecting with a bolt. A connecting hole is formed in the bottom plate part 3b of the connection terminal 3 to allow the bolt to pass through, so that the connection terminal 3 can be fastened to the electrical connecting member 8 via the bolt.

As shown in FIGS. 2-3 and 5-6, the connector 100 further comprises a pair of sleeves 4. The pair of sleeves 4 are respectively installed in the pair of side openings 12 of the insulation shell 1. The connection terminal 3 is inserted into the sleeve 4. As shown in FIG. 6, the sleeve 4 has a pair of opposite side walls 40 in the longitudinal direction Y, and a pressing spring piece 41 is formed on each of the pair of side walls 40. The pressing spring piece 41 is pressed onto the outer side of the side plate part 3a of the connection terminal 3 and is used to apply a pressing force to the side plate part 3a, so as to ensure reliable electrical contact between the side plate part 3a and the side contact part 22.

As shown in FIG. 6, the sleeve 4 also has a fixed part 42 connected to its side wall 40. As shown in FIG. 2, a slot is formed in the front wall part 14 of the insulation shell 1. The fixed part 42 is inserted and fixed into the slot of the front wall part 14 of the insulation shell 1.

An elastic buckle 42a, as shown in FIG. 6, is formed on the fixed part 42 of the sleeve 4, and a snap slot 14a, as shown in FIG. 2, is formed in the front wall part 14 of the insulation shell 1. The elastic buckle 42a is engaged with the snap slot 14a to lock the fixed part 42 of the sleeve 4 in the slot of the front wall part 14.

As shown in FIG. 7, the connection terminal 3 includes multiple U-shaped terminal laminations 31 and a terminal jacket 32 that are assembled to form the side plate part 3a and the bottom plate part 3b. The multiple U-shaped terminal laminations 31 are stacked together from the inside out and inserted into the U-shaped installation chamber 30 of the terminal jacket 32. As shown in FIG. 2, the side contact part 22 of the connection terminal 3 is inserted into the innermost one of the multiple U-shaped terminal laminations 31 and slides in electrical contact with it. The pressing spring piece 41 is pressed on the outer side of the terminal jacket 32. The U-shaped terminal lamination 31, for example, is made of pure copper or other highly conductive copper alloy materials. Further, for example, the terminal jacket 32 is made of pure copper or other highly conductive copper alloy materials.

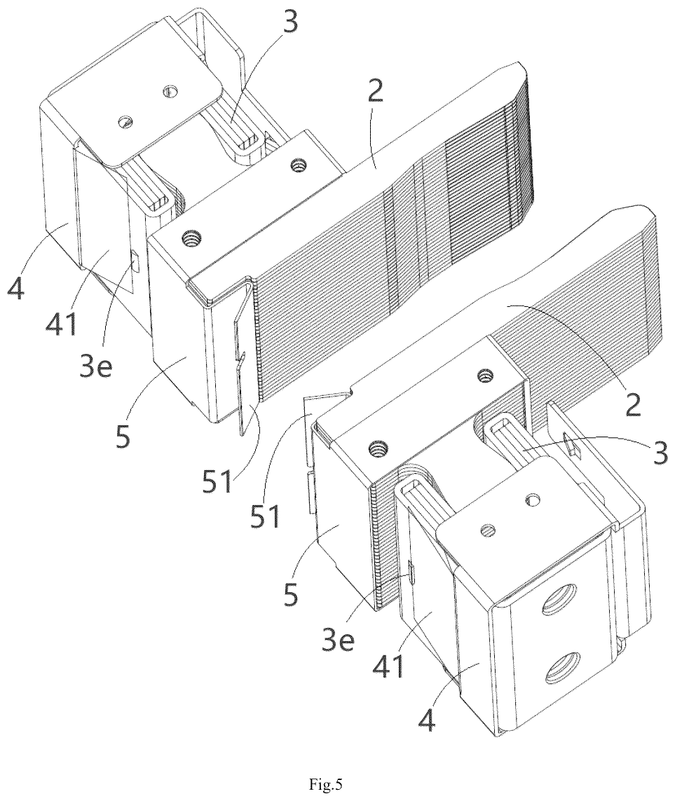

As shown in FIGS. 5-7, a limit protrusion 3e is formed on the outer side of the terminal jacket 32. The limit protrusion 3e is suitable for resting against the end of the pressing spring piece 41 to limit the sliding distance of the connection terminal 3 relative to the side contact part 22 along the transverse direction X.

As shown in FIG. 9, the two sides of the side contact part 22 of the contact terminal 2 have protruding arc-shaped contact surfaces 22a, which are used for sliding contact with the side plate part 3a of the connection terminal 3.

As shown in FIG. 2, the front contact parts 21 of the pair of contact terminals 2 are spaced opposite each other in the transverse direction X of the insulation shell 1, for electrical contact with the two sides of the mating plug inserted between them. The contact terminal 2 is rotatably installed in the insulation shell 1, and can swing within a predetermined angle range around a vertical axis extending along the height direction Z of the insulation shell 1.

A through hole 2a, as shown in FIGS. 8-9, extending along the height direction Z is formed in the contact terminal 2, and the connector 100 further includes a pivot shaft 2b, as shown in FIG. 3, that cooperates with the through hole 2a. As further shown in FIG. 3, the connector 100 has a pair of pivot shafts 2b. Each pivot shaft 2b passes through one through hole 2a and its two ends are respectively fixed to the top and bottom walls of the insulation shell 1, so that each contact terminal 2 can swing around the pivot shaft 2b.

As shown in FIG. 9, the contact terminal 2 also has a main body 20, the front contact part 21 is connected to the front end of the main body 20 and extends forward along the longitudinal direction Y. The side contact part 22 is connected to one side of the main body 20 and extends along the transverse direction X, and a through-hole 2a is formed in the main body 20 of the contact terminal 2 and located between the front contact part 21 and the side contact part 22.

As shown in FIGS. 8-9, a limit hole 2c penetrating through along the height direction Z is formed in the rear end of the main body 20 of the contact terminal 2. As shown in FIG. 3, the connector 100 also includes a pair of limit shafts 2d passing through each limit hole 2c. The two ends of the limit shaft 2d are fixed to the insulation shell 1, and the diameter of each limit shaft 2d is smaller than that of one limit hole 2c to limit the swing angle of each contact terminal 2 around each pivot shaft 2b.

As shown in FIG. 4, the insulation shell 1 has a vertical partition wall 13 located between the main bodies 20 of the pair of contact terminals 2. The front contact part 21 is biased towards one side of the main body 20 adjacent to the vertical partition wall 13, and the side contact part 22 is located on the other side of the main body 20 opposite the vertical partition wall 13.

As shown in FIG. 5, the connector 100 further comprises a pair of elastic members 5. The pair of elastic members 5 are respectively installed on the main body 20 of the pair of contact terminals 2. The elastic member 5, as shown in FIG. 9, includes a collar part 50 and an elastic part 51. The collar part 50 is fitted onto the main body 20 of the contact terminal 2. The elastic part 51 is connected to one side of the collar part 50. The elastic part 51 is in the shape of a V-shaped spring and is compressed between one side of the rear end of the contact terminal 2 and the vertical partition wall 13 of the insulation shell 1 and is used to apply elastic force to the contact terminal 2, so as to ensure reliable electrical contact between the front contact part 21 of the contact terminal 2 and the mating plug.

As shown in FIGS. 8-9, the contact terminal 2 includes multiple contact terminal laminations 2′ stacked together in the height direction Z of the insulation shell 1. The multiple contact terminal laminations 2′ are held together by the collar part 50 of the elastic member 5.

As shown in FIG. 3, the contact terminal 2 is installed into the receiving chamber 10 of the insulation shell 1 through the rear opening of the insulation shell 1. The connector 100 also includes a back cover 6, as shown in FIG. 1, installed on the rear opening of the insulation shell 1.

As shown in FIG. 4, the insulation shell 1 has a front wall part 14 and a tongue part 15 extending forward from the front wall part 14, and a front mating port 11 is formed in the front end of the tongue part 15. The connector 100 also includes a pair of grounding pieces (or grounding terminals) 7, as shown in FIG. 4, which are respectively located on both sides of the tongue part 15 and fixed to the outer sides of the front wall part 14 and the tongue part 15. The front wall part 14 of the insulation shell 1 is suitable for being fixed to a mounting panel, and the grounding piece 7 is used to make electrical contact with the mounting panel and a mating grounding piece (also known as the mating grounding terminal) of a mating connector.

As shown in FIG. 4, the grounding piece 7 is L-shaped and includes a first mounting plate 71 and a second mounting plate 72 fixed on the outer sides of the front wall part 14 and the tongue part 15, respectively. A first contact spring 7a is formed on the first mounting plate 71, which is used for electrical contact with the mounting panel. A second contact spring 7b is formed on the second mounting plate 72, which is used to make electrical contact with the mating grounding piece.

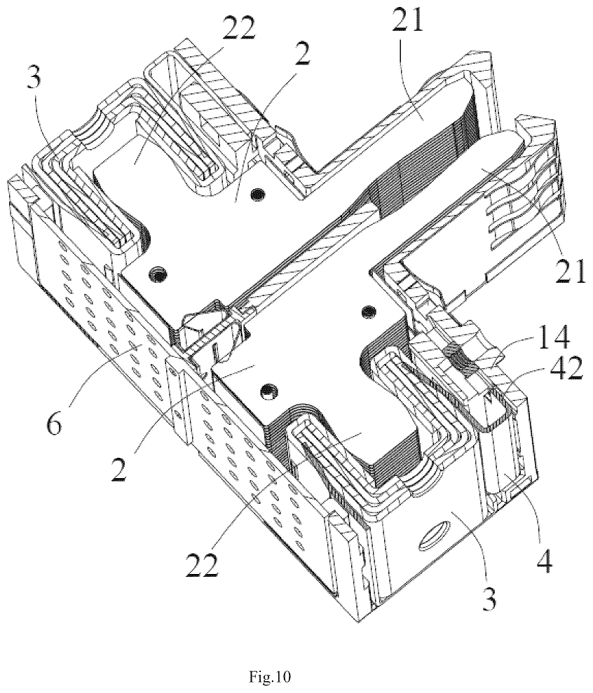

Another exemplary embodiment of a connector 100 will now be described with reference to FIGS. 10-17. A difference between the connector 100 according to FIGS. 1-9 and the embodiment of the connector 100 according to FIGS. 10-17 lies in the structure and retention method of the elastic member 5.

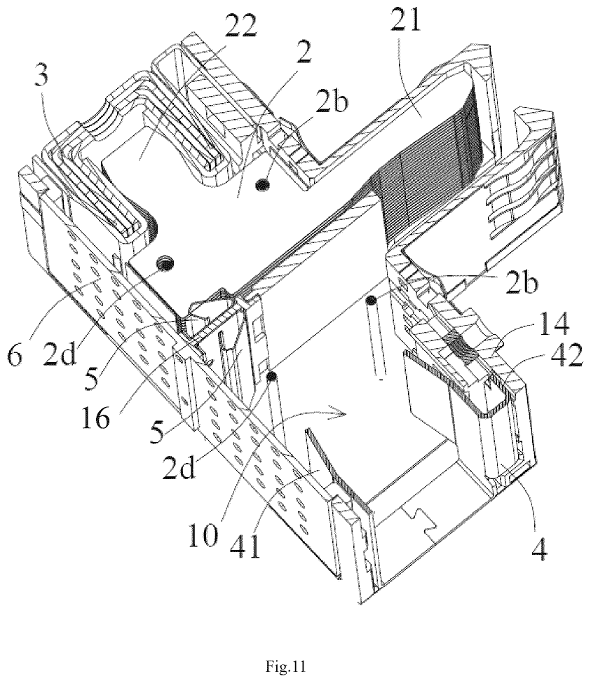

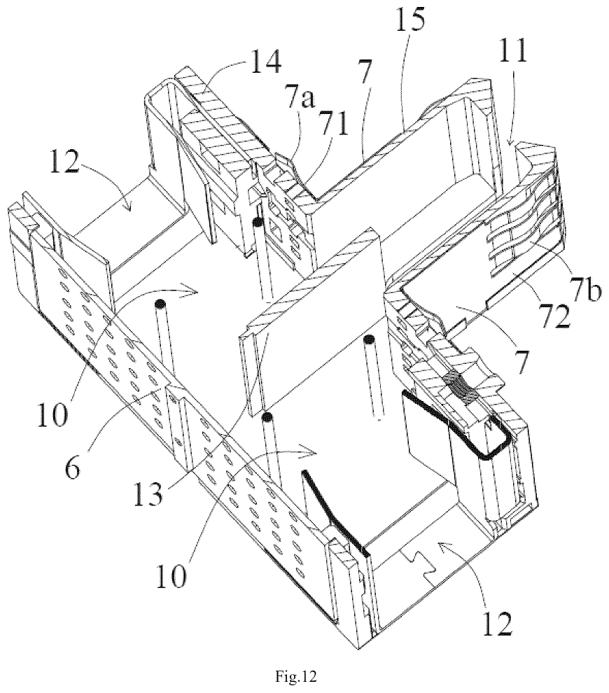

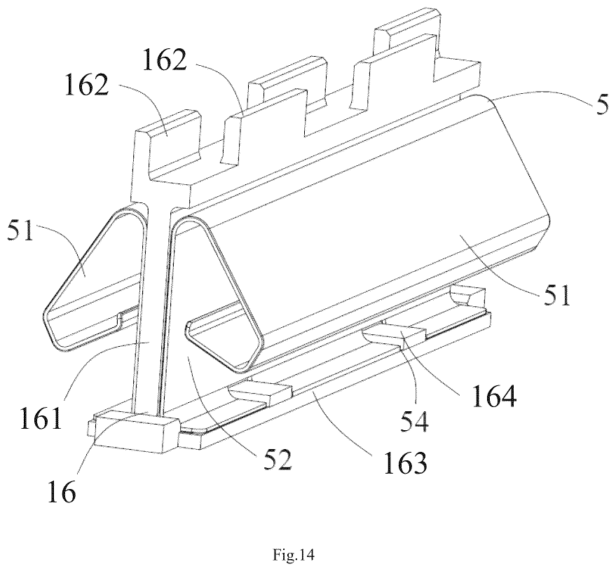

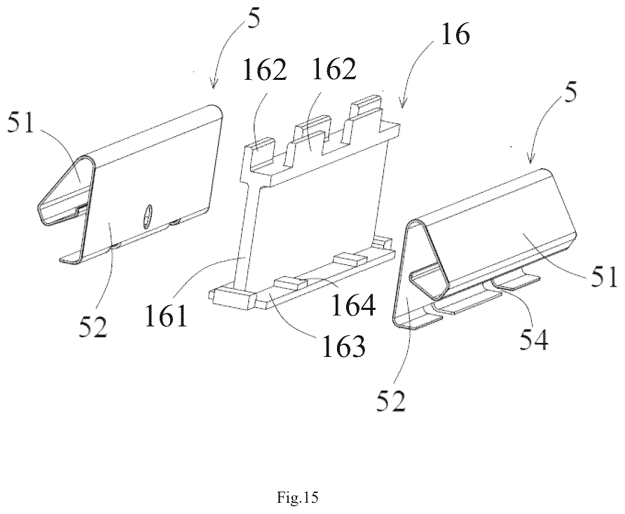

As shown in FIG. 12, there is a certain distance between the vertical partition wall 13 of the connector 100 and the back cover 6. As shown in FIG. 11, the connector 100 also includes a shuttle member 16 and a pair of elastic members 5. The shuttle member 16 is provided between the vertical partition wall 13 and the back cover 6 and is movable along the transverse direction X. The pair of elastic members 5 are respectively arranged between the shuttle member 16 and the main bodies 20 of the pair of contact terminals 2. As shown in FIGS. 14-15, the elastic member 5 includes a holding part 52 and an elastic part 51. The holding part 52 is held onto the shuttle member 16. The elastic part 51 is connected to one side of the holding part 52. The elastic part 51 is in the shape of a bent spring piece and is compressed between one side of the rear end of the contact terminal 2 and the shuttle member 16 and used to apply elastic force to the contact terminal 2, so as to ensure reliable electrical contact between the front contact part 21 of the contact terminal 2 and the mating plug.

As shown in FIGS. 14-15, the shuttle member 16 includes a longitudinal wall 161 and a pair of blocking parts 162. The longitudinal wall 161 is supported by the bottom wall of the insulation shell 1 and one end of which is located near the back cover 6 of the insulation shell 1. The pair of blocking parts 162 are connected to the other end of the longitudinal wall 161 and are spaced apart in the transverse direction X. The vertical partition wall 13 is inserted between the pair of blocking parts 162, and the distance between the pair of blocking parts 162 is greater than the width of the part of the vertical partition wall 13 inserted between the pair of blocking parts 162, so that the shuttle member 16 can move relative to the vertical partition wall 13 in the transverse direction X.

As shown in FIGS. 14-15, the shuttle member 16 further includes a transverse wall 163 provided at one end, which is close to the back cover 6 of the insulation shell 1, and a limit protrusion 164 is provided on the transverse wall 163. The holding part 52 of the elastic member 5 is L-shaped, and a notch 54 is provided on the holding part 52. The limit protrusion 164 is fitted in the notch 54 to restrict the movement of the elastic member 5 relative to the shuttle member 16 in the height direction Z. In the illustrated embodiment, the transverse wall 163 is in contact with the back cover 6. In other embodiments, there may also be a gap between the transverse wall 163 and the back cover 6.

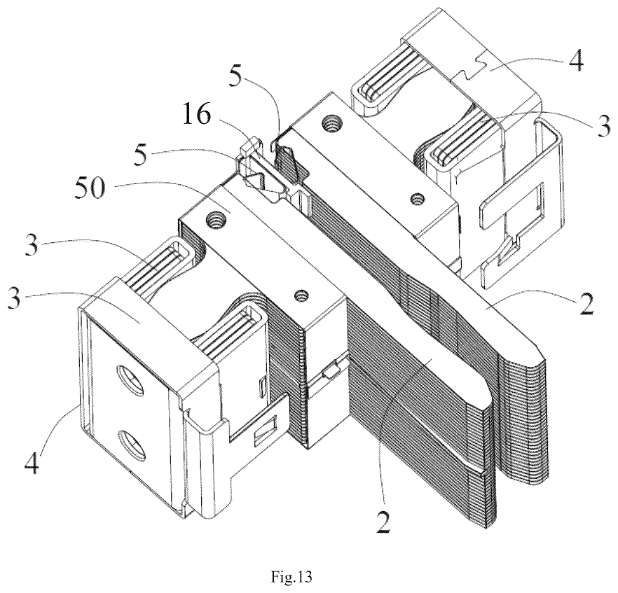

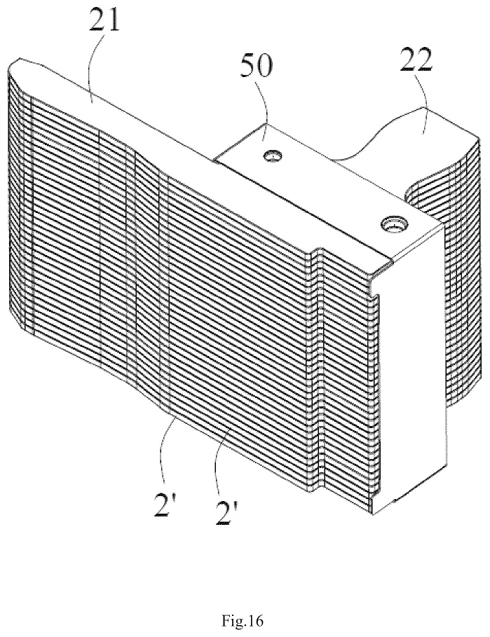

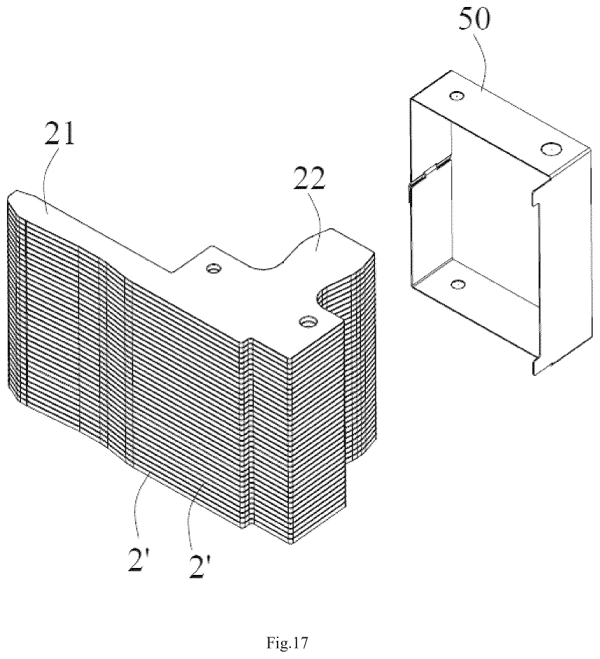

As shown in FIGS. 13 and 16-17, the connector 100 further comprises a collar part 50, which is fitted onto the main body 20 of the contact terminal 2. The contact terminal 2 includes multiple contact terminal laminations 2′, as shown in FIGS. 16-17, stacked in sequence in the height direction Z of the insulation shell 1. The multiple contact terminal laminations 2′ are held together by the collar part 50. In the illustrated embodiment, the collar part 50 and the elastic member 5 are two separate and independent components.

Except for the aforementioned differences, the other technical features of the embodiment of the connector 100 according to FIGS. 10-17 are similar to those of the connector 100 according to FIGS. 1-9, which can be referred to in the embodiment of the connector 100 according to FIGS. 1-9.

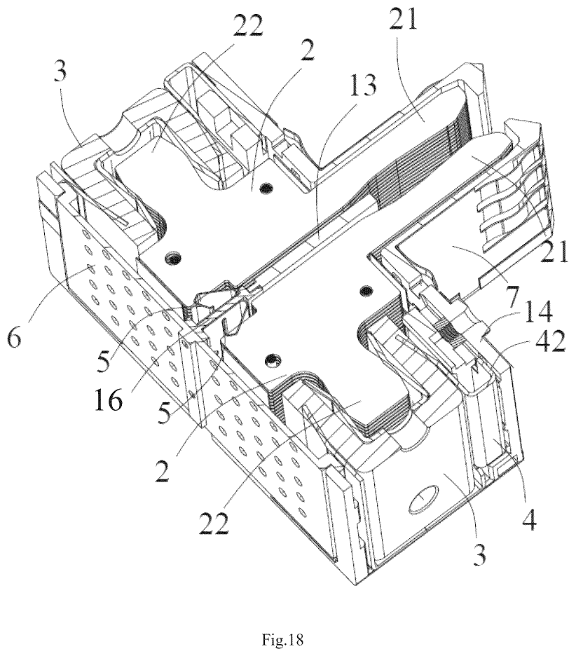

Another exemplary embodiment of a connector 100 will now be described with reference to FIGS. 18-20. A difference between the connector 100 according to FIGS. 10-17 and the embodiment of the connector 100 according to FIGS. 18-20 lies in the structure of the connection terminal 3.

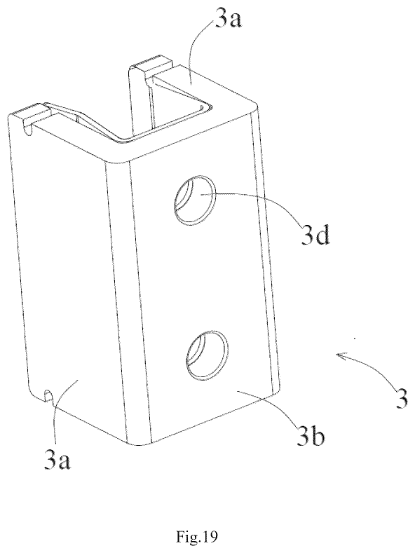

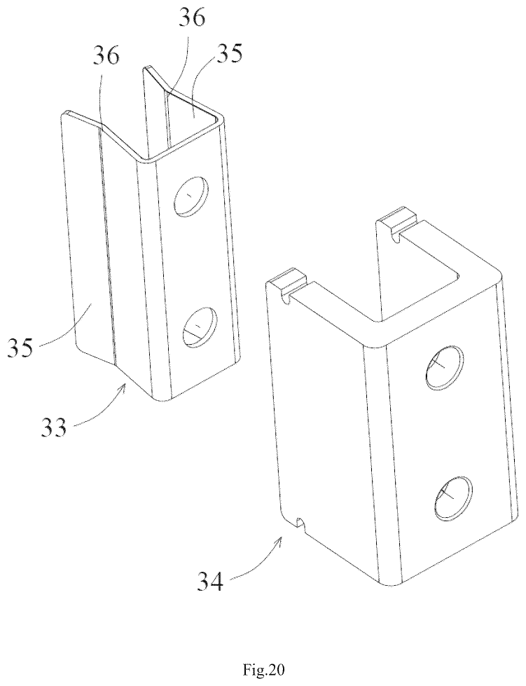

The connection terminal 3 includes a U-shaped elastic terminal piece 33 and a U-shaped terminal block 34, as shown in FIG. 20, that are assembled to form the side plate part 3a and the bottom plate part 3b, as shown in FIG. 19. The U-shaped elastic terminal piece 33 is inserted into the U-shaped terminal block 34, and the side contact part 22 of the connection terminal 3 is inserted into the U-shaped elastic terminal piece 33 and slides in electrical contact with it. The U-shaped elastic terminal piece 33 is in elastic contact with the side contact part 22 of the connection terminal 3 and the U-shaped terminal block 34. The U-shaped elastic terminal piece 33, for example, is made of copper or copper alloy material with high conductivity and elastic contact performance. Further, for example, the U-shaped terminal block 34 is made of pure copper material with high conductivity.

As shown in FIG. 20, the U-shaped elastic terminal piece 33 includes a pair of side contact pieces 35 that are opposite in the longitudinal direction Y. The pair of side contact pieces 35 have a bent shape to make elastic contact with the side contact part 22 of the connection terminal 3 and the U-shaped terminal block 34 through the pair of side contact pieces 35. In the illustrated embodiment, as shown in FIG. 20, a pair of side contact pieces 35 are bent to have protruding parts 36 facing each other, which slide in contact with both sides of the side contact part 22 of the contact terminal 2.

Except for the aforementioned differences, the other technical features of the embodiment of the connector 100 according to FIGS. 18-20 are similar to those of the connector 100 according to FIGS. 10-17, which can be referred to in the embodiment of the connector 100 according to FIGS. 10-17.

In the embodiments of the connector 100 shown in FIGS. 10-17 and 18-20, by providing a shuttle member 16 that is movable in the transverse direction X relative to the vertical partition wall 13, and two elastic members 5 respectively located between the shuttle member 16 and the two contact terminals 2, the elastic force received by the two contact terminals 2 can be transmitted to each other, avoiding the phenomenon of one side of the contact terminal 2 being subjected to a large force and the other side of the contact terminal 2 being subjected to a small force, thereby making the contact condition between the two contact terminals 2 and the corresponding connection terminals 3 more stable and reliable.

In the aforementioned exemplary embodiments of the connector 100 according to FIGS. 1-9, 10-17, and 18-20, the part of the connection terminal 3 used for electrical connection with the electrical connecting member 8 is exposed from the side opening 12 of the insulation shell 1, rather than extending from the rear side of the insulation shell 1, thereby greatly reducing the length dimension of the embodiments of the connector 100 according to FIGS. 1-9, 10-17, and 18-20 in its longitudinal direction and expanding the application range of the embodiments of the connector 100 according to FIGS. 1-9, 10-17, and 18-20.

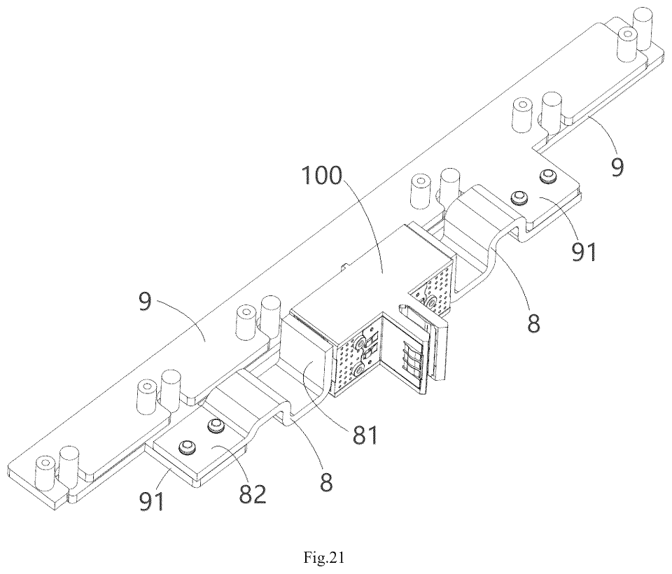

An exemplary embodiment of an electrical connection assembly will now be described with reference to FIGS. 1-21. As shown in FIG. 21, the electrical connection assembly includes one of the embodiments of the connector 100 according to FIGS. 1-9, 10-17, or 18-20, and a pair of electrical connecting members 8. One end 81 of each of the pair of electrical connecting members 8 are respectively electrically connected to the parts of the pair of connection terminals 3 of one of the embodiments of the connector 100 according to FIGS. 1-9, 10-17, or 18-20 that respectively protrude from the side openings 12 of the insulation shell 1. The electrical connecting member 8 is curved in a strip shape, allowing it to undergo elastic deformation.

As shown in FIG. 21, one end 81 of the electrical connecting member 8 is in a flat plate shape perpendicular to the transverse direction X of one of the embodiments of the connector 100. Additionally, one end 81 of the electrical connecting member 8 is fastened to the connection terminal 3 by a bolt.

As shown in FIG. 21, the electrical connection assembly further includes a pair of busbars 9. The pair of busbars 9 are respectively electrically connected to the other ends 82 of the pair of electrical connecting members 8.

The pair of busbars 9 are located on the rear side of one of the embodiments of the connector 100 according to FIGS. 1-9, 10-17, or 18-20 and extend along the transverse direction X of one of the embodiments of the connector 100. The busbars 9 are perpendicular to the height direction Z of one of the embodiments of the connector 100, and one of the busbars 9 is located above the other.

As shown in FIG. 21, the other end 82 of the electrical connecting member 8 is in a flat plate shape perpendicular to the height direction Z of one of the embodiments of the connector 100, and the busbar 9 has a flat connection end 91 perpendicular to the height direction Z of one of the embodiments of the connector 100. The other end 82 of the electrical connecting member 8 is fastened to the flat connection end 91 of the busbar 9 by a bolt.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
an insulation shell having a front mating port and a rear opening opposite each other in a longitudinal direction of the insulation shell, a pair of side openings opposite in a transverse direction of the insulation shell, and two receiving chambers arranged side by side in the transverse direction;
a pair of contact terminals each installed into one of two receiving chambers of the insulation shell and each having a front contact part and a side contact part; and
a pair of connection terminals each inserted into one of the pair of side openings and each mated with one side contact part, each front contact part is in the front mating port and electrically contacts a mating plug of a mating connector inserted into the front mating port, a part of each connection terminal is exposed from one side opening for electrical connection to an electrical connecting member.

2. The connector of claim 1, wherein each connection terminal is U-shaped, and each side contact part is inserted into one connection terminal, each connection terminal is in sliding electrical contact with one side contact part and can slide along the transverse direction.

3. The connector of claim 2, wherein each connection terminal has a pair of side plate parts opposite each other in the longitudinal direction and a bottom plate part between the pair of side plate parts, each side contact part is inserted between one pair of side plate parts and slides in electrical contact with the one pair of side plate parts.

4. The connector of claim 3, further comprising a connecting hole formed in each bottom plate part, each connecting hole allows a bolt to pass through, so that each connection terminal can be fastened to one electrical connecting member via the bolt.

5. The connector of claim 3, wherein each connection terminal has a plurality of U-shaped terminal laminations and a terminal jacket that are assembled to form the side plate part and the bottom plate part of one connection terminal, the plurality of U-shaped terminal laminations are sequentially stacked together from the inside out and inserted into a U-shaped installation chamber of the terminal jacket, each side contact part is inserted into, and makes sliding electrical contact with, the innermost one of the plurality of U-shaped terminal laminations of one connection terminal.

6. The connector of claim 3, wherein each connection terminal has a U-shaped elastic terminal piece and a U-shaped terminal block that are assembled to form the side plate part and the bottom plate part of one connection terminal, the U-shaped elastic terminal piece is inserted into the U-shaped terminal block, one side contact part is inserted into, and slides in electrical contact with, each U-shaped elastic terminal piece of each connection terminal, each U-shaped elastic terminal piece is in elastic contact with one side contact part and one U-shaped terminal block.

7. The connector of claim 6, wherein each U-shaped elastic terminal piece has a pair of opposite side contact pieces in the longitudinal direction, each pair of side contact pieces have a bent shape to elastically contact one side contact part and one U-shaped terminal block.

8. The connector of claim 3, wherein two sides of each side contact part are each formed with convex arc-shaped contact surfaces, each convex arc-shaped contact surface slidingly contacts one side plate part of the pair of side plate parts of one connection terminal.

9. The connector of claim 3, further comprising a pair of sleeves each installed in one side opening, each connection terminal is inserted into one sleeve, each sleeve has a pair of side walls opposite each other in the longitudinal direction, pressing spring pieces are formed on each side wall of the pair of side walls, each pressing spring piece is pressed on, and applies a pressing force on, an outer side of the side plate part of one connection terminal to ensure reliable electrical contact between the side plate part of one connection terminal and one side contact part.

10. The connector of claim 9, wherein each sleeve has a fixed part connected to its side wall, each fixed part is inserted and fixed into one slot formed in a front wall part of the insulation shell.

11. The connector of claim 10, wherein an elastic buckle is formed on the fixed part of each sleeve, each elastic buckle is engaged with one snap slot formed in the front wall part to lock each fixed part in one slot of the front wall part.

12. The connector of claim 1, wherein the front contact parts of the pair of contact terminals are spaced opposite each other in the transverse direction, each front contact part electrically contacts one of two sides of the mating plug inserted between the front contact parts, each contact terminal is rotatably installed in the insulation shell and can swing within a predetermined angle range around a vertical axis extending along a height direction of the insulation shell.

13. The connector of claim 12, wherein a through-hole extending along the height direction is formed in each contact terminal, and the connector further comprises a pair of pivot shafts each cooperating with one through-hole, each pivot shaft passes through one through-hole, and one of two ends of each pivot shaft is fixed to one of a top wall and a bottom wall of the insulation shell, so that each contact terminal can swing around each pivot shaft.

14. The connector of claim 13, wherein each contact terminal has a main body, the front contact part of each contact terminal is connected to a front end of one main body and extends forward along the longitudinal direction, each side contact part is connected to one side of one main body and extends along the transverse direction, each through-hole is formed in the main body of one contact terminal between one front contact part and one side contact part.

15. The connector of claim 14, wherein a rear end of the main body of each contact terminal has a limit hole penetrating through the rear end of the main body of each contact terminal along the height direction, and the connector further comprises a pair of limit shafts each passing through one limit hole, each of two ends of each limit shaft are fixed to the insulation shell, a diameter of each limit shaft is smaller than one limit hole to limit a swing angle of each contact terminal around each pivot shaft.

16. The connector of claim 14, wherein the insulation shell has a vertical partition wall between the main bodies of the pair of contact terminals, each front contact part is biased towards one side of one main body adjacent to the vertical partition wall, and each side contact part is on an other side of one main body facing away from the vertical partition wall.

17. The connector of claim 16, further comprising a pair of elastic members each installed on one main body, each elastic member has a collar part fitted onto one main body and an elastic part connected to one side of the collar part, each elastic part is in the shape of a V-shaped spring and is compressed between one side of a rear end of each contact terminal and the vertical partition wall, each elastic part applies elastic force to one contact terminal to ensure reliable electrical contact between one front contact part and the mating plug.

18. The connector of claim 16, wherein the connector further comprises a back cover, a shuttle member, and a pair of elastic members, the back cover is installed on the rear opening of the insulation shell, the vertical partition wall is spaced a certain distance from the back cover, the shuttle member is between the vertical partition wall and the back cover and is movable along the transverse direction, each elastic member is arranged between the shuttle member and one main body, each elastic member has a holding part held onto the shuttle member and an elastic part connected to one side of the holding part, each elastic part is in the shape of a bent spring piece and is compressed between one side of a rear end of one contact terminal and the shuttle member, each elastic part applies elastic force to one contact terminal to ensure reliable electrical contact between one front contact part and the mating plug.

19. The connector of claim 18, wherein the shuttle member has a longitudinal wall supported by the bottom wall of the insulation shell and one end of which is adjacent to the back cover, and a pair of blocking parts connected to an other end of the longitudinal wall and spaced opposite each other in the transverse direction, the vertical partition wall is inserted between the pair of blocking parts, a distance between the pair of blocking parts is greater than a width of a part of the vertical partition wall inserted between the pair of blocking parts, so that the shuttle member is movable relative to the vertical partition wall in the transverse direction.

20. The connector of claim 19, wherein the shuttle member has a transverse wall arranged at one end of the shuttle member, the transverse wall is adjacent to the back cover, a limit protrusion is provided on the transverse wall, the holding part of each elastic member is L-shaped, a notch is formed on each holding part, the limit protrusion is fitted in each notch to restrict a movement of each elastic member relative to the shuttle member in the height direction.

21. The connector of claim 18, wherein a collar part of each elastic member is fitted onto one main body.

22. The connector of claim 17, wherein each contact terminal has a plurality of contact terminal laminations stacked together in the height direction, the plurality of contact terminal laminations of each contact terminal are held together by one collar part.

23. The connector of claim 1, wherein the connector further comprises a pair of grounding pieces, the insulation shell has a front wall part and a tongue part extending forward from the front wall part, the front mating port is formed in a front end of the tongue part,
the pair of grounding pieces are respectively located on both sides of the tongue part and fixed to outer sides of the front wall part and the tongue part, the front wall part is fixed to a mounting panel, and each grounding piece makes electrical contact with the mounting panel and a mating grounding piece of the mating connector.

24. The connector of claim 23, wherein each grounding piece is L-shaped and includes a first mounting plate and a second mounting plate each fixed on an outer side of one of the front wall part and the tongue part, a first contact spring, electrically contacting the mounting panel, is formed on the first mounting plate, a second contact spring, electrically contacting the mating grounding piece, is formed on the second mounting plate.

25. An electrical connection assembly, comprising:
a connector including an insulation shell, a pair of contact terminals, and a pair of connection terminals, the insulation shell has a front mating port and a rear opening opposite each other in a longitudinal direction of the insulation shell, a pair of side openings opposite in a transverse direction of the insulation shell, and two receiving chambers arranged side by side in the transverse direction, the pair of contact terminals are each installed into one of two receiving chambers of the insulation shell and each have a front contact part and a side contact part, the pair of connection terminals are each inserted into one of the pair of side openings and are each mated with one side contact part, each front contact part is in the front mating port and electrically contacts a mating plug of a mating connector inserted into the front mating port, a part of each connection terminal is exposed from one side opening for electrical connection to an electrical connecting member; and
a pair of electrical connecting members, one end of each electrical connecting member is electrically connected to a portion of one connection terminal exposed from one side opening, each electrical connecting member is curved in a strip shape, allowing each electrical connecting member to undergo elastic deformation.

26. The electrical connection assembly of claim 25, wherein one end of each electrical connecting member is in a flat plate shape perpendicular to a transverse direction of the connector, and one end of each electrical connecting member is fastened to one connection terminal by a bolt.

27. The electrical connection assembly of claim 25, further comprising a pair of busbars each electrically connected to an other end of one electrical connecting member.

28. The electrical connection assembly of claim 27, wherein the pair of busbars are on a rear side of the connector and extend along the transverse direction of the connector, each busbar is perpendicular to a height direction of the connector, one of the pair of busbars is above the other.

29. The electrical connection assembly of claim 27, wherein the other end of each electrical connecting member is in a flat plate shape perpendicular to a height direction of the connector, each busbar has a flat connection end perpendicular to the height direction of the connector, the other end of each electrical connecting member is fastened to one flat connection end by a bolt.
